(19) United States
(12) Patent Application Publication
(10) Pub. No.: US 2016/0199922 A1
(43) Pub. Date: Jul. 14, 2016

(54) Method, System, Computer Program And A Computer Program Product For Measuring Objects

(71) Applicant: NOVATOR AB, Spånga (SE)

(72) Inventors: Hans-Petter Andersson, Stockholm (SE); Björn Pettersson, Järfälla (SE)

(21) Appl. No.: 14/912,414

(22) PCT Filed: Jun. 17, 2014
(86) PCT No.: PCT/SE2014/050746

§ 371 Date: Feb. 17, 2016

(30) Foreign Application Priority Data
Aug. 26, 2013 (SE) 1350971-6

(51) Int. Cl. B23C 3/00; G05B 19/18; G01B 21/00

(52) U.S. Cl. CPC B23C 3/00; G01B 21/00; G05B 19/182; B23C 2220/52; G05B 2219/45129

(57) ABSTRACT

The present invention relates to a method for measuring objects, comprising the step of providing a template (1) with at least one bushing (36-64) to a work piece (2), identifying the bushing (36-64), measuring the distance (a) between a fixed point (116) on the identified bushing (36-64) and a surface (118) of the work piece (2) facing the template (1), and collecting the measured distance (a) into a memory (126). The present invention also relates to a system for measuring and working objects comprising a computer (128) including a computer program (P) for carrying out the method. The present invention also relates to a computer program (P) and a computer program product for performing the method steps.

### TECHNICAL FIELD

The present invention relates to a method for measuring objects and a system for measuring objects comprising a computer including a computer program for carrying out the method. The present invention also relates to a computer program and a computer program product for performing the method steps.

### BACKGROUND ART

A reliable and repeatable hole quality is essential, especially in drilling applications using templates. The hole quality depends on the accuracy in measurement methods, type of hole making apparatus, tool wear and type of material in which the hole is produced.

When holes of special shapes, such as conical shapes, are produced in a work piece it is important to identify the orientation and location of the tool in relation to the work piece. When a template is arranged on the work piece the orientation of the tool in relation to the work piece is given, but for example when producing a hole provided with a countersink the depth of the countersink is critical in order to achieve an interacting connection between a fastening element and the hole provided with the countersink.

When a number of holes of a predetermined accuracy are to be made, different methods and systems are known for identifying each individual hole, collecting and registration information about the work piece and the tool when the holes are produced in the work piece, and also for measuring the holes after they have been produced in the work piece. Often such measuring methods are based on a sample of the produced holes and therefore some of the produced holes may not fulfill the high demands of accuracy.

Measuring devices and methods for measuring the position of a tool in relation to a work piece are known. Document U.S. Pat. No. 5,181,809 discloses a device and a system enabling a tool to be brought to a precise location of a drilling template. However, the device is not arranged to measure the distance between the work piece and the drilling template and therefore this device is not suitable when producing holes provided with for example a countersink.

Different types of hole making apparatuses are available. For special applications such as hole making in the fuselage of an aircraft the demands of accuracy are extremely high and therefore special hole making apparatuses should preferably be provided. Such a special hole making apparatus may use the orbital drilling technique. Orbital drilling is based on machining the material both axially and radially by rotating the cutting tool about its own axis as well as eccentrically about a principal axis while feeding the cutting tool through the material. The general principles in orbital drilling are for instance disclosed in U.S. Pat. No. 5,641,252 and EP-B1-1102653. Other types of hole making apparatuses for making holes of extremely high accuracy are also possible to use.

### SUMMARY OF THE INVENTION

Notwithstanding the existence of such prior art devices and methods described above, there is a need to produce holes with high accuracy in a work piece. There is also a need to methodize and systemize collecting and registering of information about the work piece, the tools and the produced holes during the hole making operation.

An objective problem to be solved by the present invention is therefore to methodize and systemize collection and registration of information about each individual hole among a number of holes when producing the holes.

Another objective problem to be solved by the present invention is to produce holes with high accuracy and with correct hole shape within narrow tolerances.

Still another problem to be solved by the present invention is to produce holes with a high production rate.

A further objective problem to be solved by the present invention is to systemize a hole making operation when producing a number of holes in a work piece.

A further objective problem to be solved by the present invention is to provide a method for measuring objects, which overcomes the disadvantages of prior art.

These objects above are achieved by a method for measuring objects according to claim 1, a system for measuring and working objects according to claim 14, a computer program comprising a program code according to claim 15, a computer program product comprising program code stored on a media according to claim 16, and a computer program product directly storable in an internal memory into a computer according to claim 17.

The present invention relates to a method for measuring objects, comprising the following step: providing a template with at least one bushing to a work piece. The method of the present invention is characterized in that it further comprises the steps of:
identifying the bushing;
measuring the distance between a fixed point on the identified bushing and a surface of the work piece facing the template; and
collecting the measured distance into a memory.

According to the solution of the present invention, it was realized that the holes can be produced with high accuracy and with correct hole shape within narrow tolerances at high production rate.

According to a further embodiment of the present invention the method comprises working of the work piece, whereby the method further comprises the steps of:
identifying the bushing;
providing a work tool on the identified bushing;
bringing the measured distance for the identified bushing from the memory; and
working the work piece based on said measured distance.

According to this further embodiment, it was realized that the holes can be produced with high accuracy and with correct hole shape within narrow tolerances at a high production rate.

According to a further embodiment of the present invention the method comprises the further step of collecting data from the working operation into the memory.

According to this further embodiment, it was realized that when methodizing and systemizing the collection and registration of information about each individual hole among a number of holes, the holes can be produced with high accuracy and with correct hole shape within narrow tolerances at a high production rate.

According to a further embodiment of the present invention the method comprises the further steps of:
identifying the bushing;
measuring the work piece with respect to the result of the working operation;
collecting the measured values into the memory.

According to this further embodiment, it was realized that the collected measured values stored into the memory may be used for documentary reasons. When drilling a large number of holes into for example an aircraft fuselage it is important to collect and store information about the characteristics of each hole drilled in the fuselage and also to have the possibility to identify each individual hole in the fuselage.

According to this further embodiment, it was also realized that the collected information of the working operation may be used for matching the worked work piece with different components, such as fastening elements.

The present invention also relates to a computer program and a computer program product for performing the method steps according to the present invention.

By the term “hole” is meant forming of an opening or recess in the material by the working process that results in a hole configuration or geometry. Thus, the hole is not limited to a circular hole but can be of any shape, such as triangular, polygonal shaped or a counter sink hole. The hole can be a through hole or a blind hole. Hence, by the term hole “diameter” is meant any distance straight across the opening that forms the hole and not only the largest opened distance cross the hole.

### BRIEF DESCRIPTION OF THE DRAWINGS

The invention will hereinafter be described with reference to an embodiment of the invention and the enclosed figures, where

FIG. 1 shows a section view of a template connected to a work piece,

FIG. 2 shows a plane view of the template in FIG. 1,

FIG. 3 shows a side view of an orbital drilling apparatus,

FIG. 4 shows a side view of a measuring instrument, and

FIG. 5 illustrates a method according to an embodiment of the present invention in a block diagram.

### DETAILED DESCRIPTION

The method for measuring objects and the system for measuring objects comprising a computer including a computer program for carrying out the method according to an embodiment of the present invention will now be described by way of example only. The disclosure is not intended to limit the scope of the enclosed claims in any way.

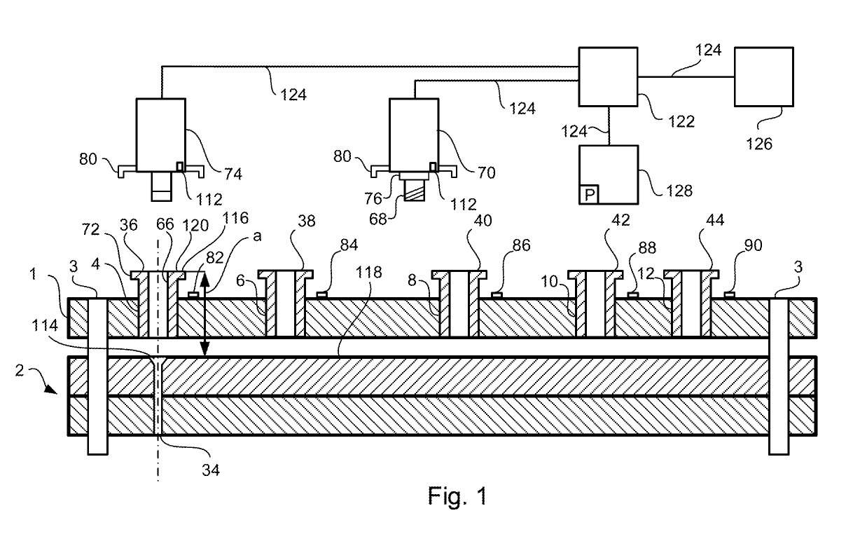

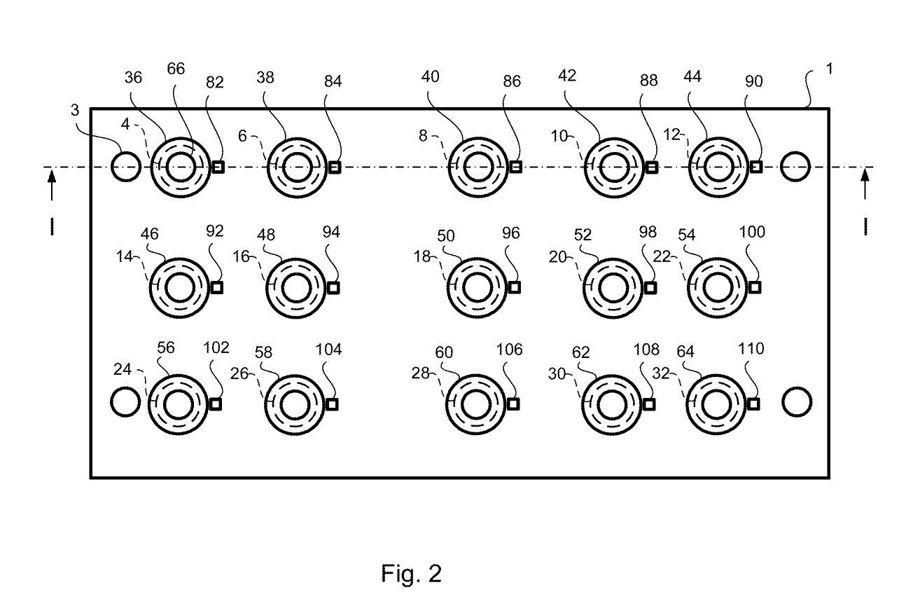

FIGS. 1 and 2 shows a section view and a plane view, respective of a template 1 connected to an object, such as a work piece 2, by means of connecting elements 3. FIG. 1 represent the section view along line I-I in FIG. 2: The template 1 is provided with a plurality of openings 4, 6, 8, 32 located in a pattern corresponding to the positions of holes 34 to be formed in the work piece 2 to which the template 1 is attached. Guide bushings 36, 38, 40, . . . 64 are inserted in the openings 4-32 of the template 1 to form guide holes 66 for a rotary cutting tool 68. The bushings 36-64 are provided with a flange 72 for the fixation of the work tool such as a drilling machine 70 and also a measuring instrument 74 to the template 1.

The drilling machine 70 has a drill chuck 76 for holding the rotary cutting tool 68 and a suitable fixation device 78 for fixating the machine 70 to the bushings 36-64 of the template 1. Also, the measuring instrument 74 has a suitable fixation arrangement 80 for fixating the instrument 74 to the bushings 36-64 of the template 1. The work piece 2 may consist of composite materials, such as fibre-reinforced composite materials, laminates, stacks of identical or various materials, etc. In order to produce holes 34 of various configurations and dimensions therein with help of one and the same cutting tool 68 use of a portable drilling machine 70 is preferred. As many holes 34 of various size and configurations are to be formed in a rapid sequence, the operator may have difficulties in identifying the bushing 36-64 on which the machine 70 is fixated, and establishing which specific hole-cutting processing data should be applied by the drilling machine 70 to the guide hole 66 in question.

According to the invention a unique, individual marking or information carrier 82, 84, 86, . . . 110 containing an identification of the hole 34 to be formed is affixed adjacent to each bushing 36-64 on the template 1. The markings or information carriers 82-110 may consist of any suitable type of readable ID, such as a RFID tag or chip, a bar code, a colour marking, etc., and can be identified by a reader or sensor 112 on the measuring instrument 74 and on the drilling machine 70. Alternatively, each bushing 36-64 may be identified by means of a local orientation system in three dimensions where the position of the bushings 36-64 may be identified in relation to a number of transmitters (not disclosed) and/or reference points located adjacent to or in the vicinity of the template 1.

When producing holes 34 provided with a countersink 114 the depth of the countersink 114 in the work piece 2 is critical in order to achieve an interacting connection between a fastener element (not disclosed) and the hole 34 provided with the countersink 114. Therefore, a distance a between a fixed point 116 on the identified bushing 36-64 and a surface 118 of the work piece 2 facing the template 1 must be determined in order to know how deep the cutting tool 68 should be feeded into the work piece 2 when making the hole 34. The measuring instrument 74 is provided on the identified bushing 36-64 for measuring the distance a between the fixed point 116 on the identified bushing 36-64 and the surface 118 of the work piece 2 facing the template. Preferably, the fixed point 116 on the identified bushing 36-64 coincide with a surface 120 on the bushing 36-64 which facing away from said surface 118 of the work piece 2. The measuring instrument 74 is adapted to be connected to the flange 72 of the bushings 36-64.

The drilling machine 70 and the measuring instrument 74 are connected to a control unit 122 by means of electrical wires 124. Also, a memory 126 is connected to the control unit 122 by means of electrical wires 124. The control unit 122 and the memory 126 may be installed into the drilling machine 70 or as separate units outside the drilling machine 70 and the measuring instrument 74. The drilling machine 70 and the measuring instrument 74 may also communicate wireless with the control unit 122 and the memory 126.

The drilling is controlled by a control unit 122. The control unit 122 receives information from the memory 126 about a receipt containing for example collected tool and material parameters, whereby the control unit 122 uses the information for running the drilling operation. The control unit 122 is preferably run by a computer 128, having a software algorithm adapted for providing calculations.

When attaching the drilling machine 70 to one of the bushings 36-64 on the template 1, the sensor 112 will detect the hole identity of the adjacent information carrier 82-110 and transmit it to the memory 126 containing all relevant information of the respective hole 34 to be formed, such as type of hole 34, various processing and dimensional parameters thereof, e.g. diameter, depth and configuration of the hole 34, cutting advancement speed, shape of countersinks 114, etc. Then, the control unit 122 is adapted to control the machine 70 to carry out the relevant hole cutting process in the work piece 2. Thus, the operator may only have to fixate the drilling machine 72 on the bushing 36-64 and to activate it to initiate the relevant hole-cutting process.

After the production of all holes 34 in the work piece 2 a control measurement thereof may be performed by means of the measuring instrument 74 to establish any discrepancies from the predetermined parameters requiring renewed treatment of the hole in question or to match the hole 34 with a suitable fastening element having dimensions adapted to the hole 34. The drilling machine 70, the measuring instrument 74, the control unit 122, the computer 128 and the memory 126 may be connected to a local network. Measurement results of the drilled holes 34 are stored in the memory 126. The data from the memory 126 may then be used for checking whether the holes 34 in the work piece 2 have been drilled in a correct sequence, at the right time, with the correct parameters, by a correct cutting tool 68, etc.

The drilling machine 70 may be an orbital drilling apparatus which is characterized by a cutting tool diameter that is less than the diameter of the resulting hole 34; a tool cutting edge that is intermittently in contact with the hole edge; small chip formation; and a low thrust force.

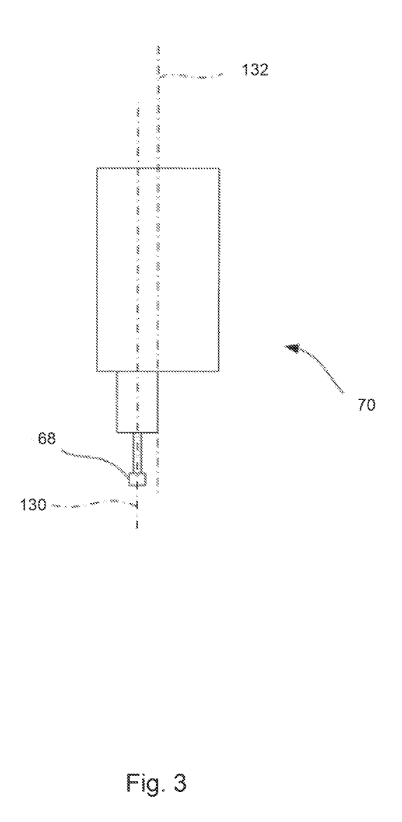

FIG. 3 shows a side view of the drilling machine 70 in form of an orbital drilling apparatus, comprising a cutting tool 68 for drilling a hole in a work piece 2. The cutting tool 68 has a cutting tool axis 130. The cutting tool 68 is rotated about its own axis 130 as well as eccentrically about a principal axis 132 of the orbital drilling apparatus.

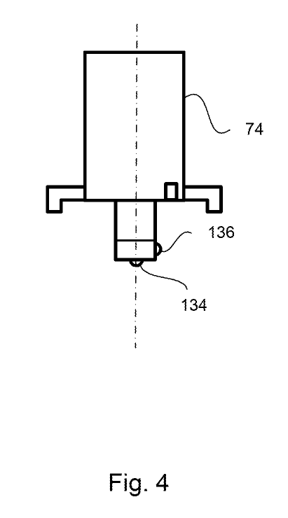

FIG. 4 shows a side view of the measuring instrument 74, comprising a first and a second probe 134, 136 which are directed in different directions. When performing the measuring of the distance a, the first probe 134 is preferably directed towards the surface 118 of the work piece 2. When performing the measuring of the shape of the worked hole 34 the second probe 136 is preferably directed in a radial direction to the worked hole 34 in the work piece 2 or in an angel in relation to the radial direction to the worked hole 34 in the work piece 2. However, it is also possible to provide to different measuring instruments 74, one instrument comprising a first probe 134 directed towards the surface 118 of the work piece 2 and another instrument comprising a second probe 136 directed in a radial direction to the worked hole 34 in the work piece 2.

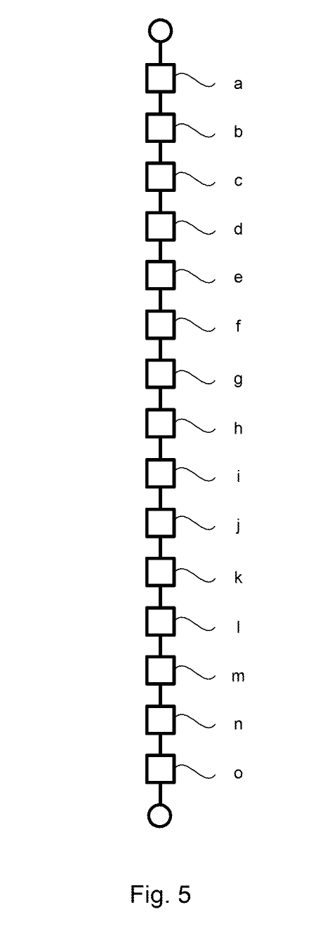

In operation, the method according to an embodiment of the present invention is illustrated in a block diagram in FIG. 5.

The method comprising the step of:

a) providing a template 1 with at least one bushing 36-64 to a work piece 2.
b) identifying the bushing 36-64;
c) measuring the distance a between a fixed point 116 on the identified bushing 36-64 and a surface 118 of the work piece 2 facing the template 1; and
d) collecting the measured distance a into a memory 126.

The work piece 2 may be of any suitable material or a combination of materials arranged in a stack. Preferably, the fixed point 116 on the identified bushing 36-64 coincide with a surface 120 on the bushing 36-64 which facing away from said surface 118 of the work piece 2. Preferably, the bushing 36-64 is identified by means of a RFID tag arranged on the bushing 36-64 or on the template 2. However, the bushing 36-64 is identified by means of any suitable type of readable information carrier 82-110, such as a RFID tag or chip, a pin code, a colour marking, etc., and can be identified by a reader or sensor 112 of the drilling machine 70. Alternatively, each bushing 36-64 may be identified by means of a GPS system (not disclosed).

The method comprises also working of the work piece, whereby the method further comprises the steps of:

e) identifying the bushing 36-64;
f) providing a work tool 70 on the identified bushing 36-64;
g) bringing the measured distance a for the identified bushing 36-64 from the memory 126; and
h) working the work piece 2 based on said measured distance a.

Because the distance a, between the fixed point 116 on the identified bushing 36-64 and a surface 118 of the work piece 2 facing the template 1 is known and collected into the memory 126 the work piece 2 may be worked with very narrow tolerances with regard to depth in the work piece 2 when for example drilling a hole 34 with a countersink 114. Preferably, the work tool 70 is connected to a control unit 122 and comprises an orbital cutting apparatus having an axis 130, the cutting tool 68 is rotated about its own axis 130 as well as eccentrically about a principal axis 132. However, the work tool 70 may be another type of tool, such as a conventional drilling tool. Preferably, the control unit 122 is run by a computer 128, having a software algorithm adapted for providing calculations about the working operation.

The method comprises the further step of:

i) collecting data from the working operation into the memory 126.

The data collected from the working operation may for example be cutting length, feed length, spindle speed, feed rate and hole depth.

The method comprises the further steps of:

j) identifying the bushing 36-64;
k) measuring the work piece 2 with respect to the result of the working operation;
l) collecting the measured values into the memory 126.

After the working operation the work piece 2 is measured with respect to the result of the working operation. If the working operation comprises making of holes 34, values are measured and data about hole shape, depth, diameter, countersink characteristics and cylindricity is collected into the memory 126. This collected data may be used to match the hole 34 with a fastening element (not disclosed) with complementary characteristics in relation to the characteristics of the hole 34. If the hole 34 for example is under sized in relation to predetermined characteristics of the hole 34 it may be possible to find a fastening element which may compensate for the deflection of the hole 34.

The method comprises the further step of:

m) making counter sink holes 34 when working the work piece 2 in step h).

When producing a hole 34 provided with a countersink 114 the depth of the countersink 114 is critical in order to achieve an interacting connection between the fastener element and the hole 34 provided with the countersink 114. Preferably, the countersink 114 has a conical shape. However, depending on the working method it may also be possible to provide the countersink 114 with the shape of a pyramid. In order to achieve a predetermined shape of the countersink 114 the distance between a fixed point 116 on the identified bushing 36-64 and a surface 118 of the work piece 2 facing the template 1 is crucial.

The method comprises the further step of:

n) bringing additional predetermined working parameters related to the identified bushing 36-64 from the memory 126, such as number of holes 34 to drill, thickness of the work piece 2, cutting length, feed length, spindle speed, feed rate and hole depth before working the work piece 2 in step h).

These predetermined working parameters may be stored into the memory 126 as a recipe for the working process.

The method comprises the further step of:

o) providing a measuring instrument 74 on the identified bushing 36-64 before step c) and before step k) for measuring the distance a between the fixed point 116 on the identified bushing 36-64 and the surface 118 of the work piece 2 facing the template 1, and for measuring the work piece 2 with respect to the result of the working operation.

The measuring instrument 74 may comprise two different probes 134, 136 which are directed in different directions. When performing the measuring in step c) the probe 134 is preferably directed towards the surface 118 of the work piece 2. When performing the measuring in step k) the probe 136 is preferably directed in a radial direction to the worked hole 34 in the work piece 2. However, it is also possible to provide to different measuring instruments 74, one instrument comprising a probe 134 directed towards the surface 118 of the work piece 2 and another instrument comprising a probe 136 directed in a radial direction to the worked hole 34 in the work piece 2. Preferably, the measuring instrument 74 is connected to a control unit 122, which is run by a computer 128, having a software algorithm adapted for providing calculations about the measuring operation.

The system for measuring and working objects comprises a computer 128 including a computer program P for carrying out the method according to the invention, in which a software algorithm provides said calculations about the measuring operation.

The present invention also relates to a computer program P and a computer program product for performing the method steps. The computer program P comprises a program code for performing the method steps according to the present invention as mentioned herein, when said computer program P is run on a computer 128. The computer program product comprises a program code stored on a, by a computer 128 readable, media for performing the method steps according to the present invention as mentioned herein, when said computer program P is run on the computer 128. Alternatively, the computer program product is directly storable in an internal memory into the computer 128, comprising a computer program P for performing the method steps according to the present invention, when said computer program P is run on the computer 128.

An aspect of the invention relates to a computer program P comprising a program code for performing the steps of:

a) providing a template 1 with at least one bushing 36-64 to a work piece 2;
b) identifying the bushing 36-64;
c) measuring the distance a between a fixed point 116 on the identified bushing 36-64 and a surface 118 of the work piece 2 facing the template 1; and
d) collecting the measured distance a into a memory 126, when said computer program P is run on a computer 128.

As a further aspect of the invention, the computer program P comprising a program code for performing the steps of:

e) identifying the bushing 36-64;
f) providing a work tool 70 on the identified bushing 36-64;
g) bringing the measured distance a for the identified bushing 36-64 from the memory 126;
h) working the work piece 2 based on said measured distance a;
i) collecting data from the working operation into the memory 126;
j) identifying the bushing 36-64;
k) measuring the work piece 2 with respect to the result of the working operation;
l) collecting the measured values into the memory 126;
m) making counter sink holes 34 when working the work piece 2 in step h);
n) bringing additional predetermined working parameters related to the identified bushing 36-64 from the memory 126, such as number of holes 34 to drill, thickness of the work piece 2, cutting length, feed length, spindle speed, feed rate and hole depth before working the work piece 2 in step h); and
o) providing a measuring instrument 74 on the identified bushing 36-64 before step c) and before step k) for measuring the distance a between the fixed point 116 on the identified bushing 36-64 and the surface 118 of the work piece 2 facing the template 1, and for measuring the work piece 2 with respect to the result of the working operation, when said computer program P is run on a computer 128.

The computer program P may for example present information on a display to an operator who performs some or all of the activities in the steps a)-o). Alternatively or in combination, the computer program P may control a robot which performs some or all of the activities in these steps.

An aspect of the invention relates to a computer program product comprising a program code stored on a, by a computer 128 readable, media for performing steps of:

a) providing a template 1 with at least one bushing 36-64 to a work piece 2;
b) identifying the bushing 36-64;
c) measuring the distance a between a fixed point 116 on the identified bushing 36-64 and a surface 118 of the work piece 2 facing the template 1; and
d) collecting the measured distance a into a memory 126, when said computer program P is run on a computer 128.

As a further aspect of the invention, the computer program product comprising a program code stored on a, by a computer 128 readable, media for performing steps of:

e) identifying the bushing 36-64;
f) providing a work tool 70 on the identified bushing 36-64;
g) bringing the measured distance a for the identified bushing 36-64 from the memory 126;
h) working the work piece 2 based on said measured distance a;
i) collecting data from the working operation into the memory 126;
j) identifying the bushing 36-64;
k) measuring the work piece 2 with respect to the result of the working operation;
l) collecting the measured values into the memory 126;
m) making counter sink holes 34 when working the work piece 2 in step h);
n) bringing additional predetermined working parameters related to the identified bushing 36-64 from the memory 126, such as number of holes 34 to drill, thickness of the work piece 2, cutting length, feed length, spindle speed, feed rate and hole depth before working the work piece 2 in step h); and
o) providing a measuring instrument 74 on the identified bushing 36-64 before step c) and before step k) for measuring the distance a between the fixed point 116 on the identified bushing 36-64 and the surface 118 of the work piece 2 facing the template 1, and for measuring the work piece 2 with respect to the result of the working operation, when said computer program P is run on a computer 128.

An aspect of the invention relates to a computer program product directly storable in an internal memory into a computer 128, comprising a computer program P for performing the steps of:

a) providing a template 1 with at least one bushing 36-64 to a work piece 2;
b) identifying the bushing 36-64;
c) measuring the distance a between a fixed point 116 on the identified bushing 36-64 and a surface 118 of the work piece 2 facing the template 1; and
d) collecting the measured distance a into a memory 126, when said computer program P is run on a computer 128.

As a further aspect of the invention, the computer program product directly storable in an internal memory into a computer 128, comprising a computer program P for performing the steps of:

e) identifying the bushing 36-64;
f) providing a work tool 70 on the identified bushing 36-64;
g) bringing the measured distance a for the identified bushing 36-64 from the memory 126;
h) working the work piece 2 based on said measured distance a;
i) collecting data from the working operation into the memory 126;
j) identifying the bushing 36-64;
k) measuring the work piece 2 with respect to the result of the working operation;
l) collecting the measured values into the memory 126;
m) making counter sink holes 34 when working the work piece 2 in step h);
n) bringing additional predetermined working parameters related to the identified bushing 36-64 from the memory 126, such as number of holes 34 to drill, thickness of the work piece 2, cutting length, feed length, spindle speed, feed rate and hole depth before working the work piece 2 in step h); and
o) providing a measuring instrument 74 on the identified bushing 36-64 before step c) and before step k) for measuring the distance a between the fixed point 116 on the identified bushing 36-64 and the surface 118 of the work piece 2 facing the template 1, and for measuring the work piece 2 with respect to the result of the working operation, when said computer program P is run on a computer 128.

Features and components of the different embodiments above may be combined within the scope of the invention.

1. A method for measuring objects, comprising the step of:
a) providing a template (1) with at least one bushing (36-64) to a work piece (2);
characterized in that the method further comprises the steps of:
b) identifying the bushing (36-64);
c) measuring the distance (a) between a fixed point (116) on the identified bushing (36-64) and a surface (118) of the work piece (2) facing the template (1); and
d) collecting the measured distance (a) into a memory (126).

2. A method according to claim 1, characterized in that the method comprises working of the work piece (2), whereby the method further comprises the steps of:
e) identifying the bushing (36-64);
f) providing a work tool (70) on the identified bushing (36-64);
g) bringing the measured distance (a) for the identified bushing (36-64) from the memory (126); and
h) working the work piece (2) based on said measured distance (a).

3. A method according to claim 2, characterized in the further step of:
i) collecting data from the working operation into the memory (126).

4. A method according to claim 2, characterized in the further steps of:
j) identifying the bushing (36-64);
k) measuring the work piece (2) with respect to the result of the working operation; and
l) collecting the measured values into the memory (126).

5. A method according to claim 2, characterized in the further step of:
m) making counter sink holes (34) when working the work piece (2) in step h).

6. A method according to claim 2, characterized in the further step of:
n) bringing additional predetermined working parameters related to the identified bushing (36-64) from the memory (126), comprising one or more of number of holes (34) to drill, thickness of the work piece (2), cutting length, feed length, spindle speed, feed rate, or hole depth before working the work piece (2) in step h).

7. A method according to claim 2, characterized in that the work tool (70) is connected to a control unit (122).

8. A method according to claim 2, characterized in that the work tool (70) comprises an orbital cutting apparatus having an axis (130), the cutting tool (68) being rotated about its own axis (130) as well as eccentrically about a principal axis (132).

9. A method according to claim 1, characterized in the further steps of:
j) identifying the bushing (36-64);
k) measuring the work piece (2) with respect to the result of the working operation;
l) collecting the measured values into the memory (126); and
o) providing a measuring instrument (74) on the identified bushing (36-64) before step c) and before step k) for measuring the distance (a) between the fixed point (116) on the identified bushing (36-64) and the surface (118) of the work piece (2) facing the template (1), and for measuring the work piece (2) with respect to the result of the working operation.

10. A method according to claim 9, characterized in that the measuring instrument (74) is connected to a control unit (122).

11. A method according to claim 1,
characterized in that the bushing (36-64) is identified by means of a RFID tag (82-110) arranged on the bushing (36-64) or on the template (1).

12. A method according to claim 1, characterized in that the fixed point (116) on the identified bushing (36-64) coincides with a surface (120) on the bushing (36-64) which faces away from said surface (118) of the work piece (2).

13. A method according to claim 7, characterized in that the control unit (122) is run by a computer (128), having a software algorithm adapted for providing calculations about the measuring and working operation.

14. A system for measuring and working objects comprising a computer (128) including a computer program (P) for carrying out the method steps according to claim 1, in which a software algorithm provides said calculations.

15. A computer program (P) comprising a program code for performing the method steps of claim 1, when said computer program (P) is run on a computer (128).

16. A computer program product comprising a program code stored on media, readable by a computer (128) for performing the method steps of claim 1, when said computer program (P) is run on the computer (128).

17. A computer program product directly storable in an internal memory into a computer (128), comprising a computer program (P) for performing the method steps according to claim 1, when said computer program (P) is run on the computer (128).
